(19) United States
(12) Patent Application Publication
(10) Pub. No.: US 2010/0108780 A1
(43) Pub. Date: May 6, 2010

(54) LIQUID ATOMIZATION DEVICE AND METHOD

(76) Inventors: Ashok V. Joshi, Salt Lake City, UT (US); John Howard Gordon, Salt Lake City, UT (US)

Correspondence Address: CERAMATEC, INC., 2425 SOUTH 900 WEST, SALT LAKE CITY, UT, 84119, US

(21) Appl. No.: 12/610,556

(22) Filed: Nov. 2, 2009

Related U.S. Application Data
(60) Provisional application No. 61/110,315, filed on Oct. 31, 2008.
(60) Provisional application No. 61/238,596, filed on Aug. 31, 2009.

(51) Int. Cl. B05B 15/00

(52) U.S. Cl. 239/289

(57) ABSTRACT

A device and method for atomizing a liquid for delivery to a target zone are presented. The liquid atomization device may include a liquid reservoir to contain a liquid, and a liquid pathway to receive at least a portion of the liquid from the liquid reservoir. The liquid pathway may include one end communicating with the liquid reservoir, and another end communicating with a target zone. Two electrodes may be placed in the liquid pathway to accommodate the liquid therebetween. An AC power source may be connected to each of the electrodes to generate an alternating current through the liquid, thereby atomizing at least a portion of the liquid for delivery to the target zone.

### RELATED APPLICATIONS

This application claims priority to U.S. Provisional Patent App. No. 61/110,315 filed on Oct. 31, 2008 and entitled APPARATUS AND METHOD FOR ATOMIZING A LIQUID. This application further claims priority to U.S. Provisional Patent App. No. 61/238,596 filed on Aug. 31, 2009 and entitled METHOD AND DEVICE FOR VAPORIZATION OF A LIQUID.

### BACKGROUND OF THE INVENTION

1. Field of the Invention

This invention relates to delivery devices, and more particularly to devices and methods for atomizing a liquid to facilitate delivery to a target zone.

2. Background

Many beneficial substances, such as deodorizers, fragrances, insect repellants, insecticides, and the like, are commercially available in liquid form. Often, such liquids are packaged in containers such as spray bottles or aerosol cans so the liquids can be converted to a fine mist or spray. This allows the liquids to be finely dispersed over a large target zone to provide a beneficial effect.

Various delivery devices aim to maximize the beneficial effects of such a liquid over an extended period of time. For example, automatic air fresheners may be designed to periodically spray a predetermined amount of fragrance into the air over time via a pressurized pump. These systems, however, are generally mechanically complex, requiring numerous moving parts and associated expense.

Other delivery techniques involve automatically or periodically heating a container over time to atomize its beneficial liquid contents. Indeed, some beneficial liquids require a thermal input to provide the energy needed for them to rise to a temperature where atomization readily occurs, and may require additional thermal input for the “heat of vaporization,” which carries the liquid into a vapor phase.

Many fragrances and other beneficial liquids, however, become particularly volatile when exposed to heat and may decompose on heat transfer surfaces. As a result, extended heating periods may prematurely denature the beneficial liquid, initially producing a highly potent effect that quickly diminishes. Intermittent heating periods, however, may be inefficient with respect to the amount of energy required to effectuate liquid atomization. Intermittent heating periods may also prove largely ineffective due to slow vaporization response times resulting from inefficiencies in heat transfer from the container to the liquid.

In view of the foregoing, what is needed is a device and method to efficiently atomize a liquid for delivery to a target zone. Beneficially, such a device and method would effectuate a fast vaporization response time, minimize the amount of energy needed to atomize the liquid, and enable simple and inexpensive manufacture and use. Such a device and method are disclosed and claimed herein.

### SUMMARY

The invention has been developed in response to the present state of the art and, in particular, in response to the problems and needs in the art that have not yet been fully solved by currently available devices and methods. Accordingly, the invention has been developed to provide a device and method for atomizing a liquid that overcomes various shortcomings of the prior art. The features and advantages of the invention will become more fully apparent from the following description and appended claims, or may be learned by practice of the invention as set forth hereinafter.

Consistent with the foregoing, a liquid atomization device in accordance with the invention may include a liquid reservoir to contain a liquid, and a liquid pathway to receive at least a portion of the liquid from the liquid reservoir. The liquid pathway may include one end communicating with the liquid reservoir, and another end communicating with a target zone. Two electrodes may be placed in the liquid pathway to accommodate the liquid therebetween. An AC power source may be connected to each of the electrodes to generate an alternating current through the liquid, thereby atomizing at least a portion of the liquid for delivery to the target zone.

A corresponding method is also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings in which:

FIG. 1 is a cross-sectional side view of one embodiment of a liquid atomization device in accordance with the invention;

FIG. 2A is a cross-sectional top view of one embodiment of a liquid pathway that may be included in a liquid atomization device in accordance with the invention;

FIG. 2B is a cross-sectional side view of the liquid pathway illustrated in FIG. 2A;

FIG. 3A is a cross-sectional top view of another embodiment of a liquid pathway in accordance with the invention;

FIG. 3B is a cross-sectional side view of the liquid pathway illustrated in FIG. 3A;

FIG. 4A is a cross-sectional top view of yet another embodiment of a liquid pathway in accordance with the invention;

FIG. 4B is a cross-sectional side view of the liquid pathway illustrated in FIG. 4A;

FIG. 5 is a cross-sectional side view of a liquid atomization device constructed and used for testing purposes;

FIG. 6 is a graphical representation of a thermogravimetric analysis and a differential thermal analysis experimentally obtained for the liquid atomization device illustrated in FIG. 5;

FIG. 7 is a graphical representation of fragrance delivery rates experimentally obtained for the liquid atomization device illustrated in FIG. 5;

FIG. 8 is a cross-sectional side view of another liquid atomization device constructed and used for testing purposes;

FIG. 9 is a graphical representation of fragrance delivery rates experimentally obtained for the liquid atomization device illustrated in FIG. 8; and

FIG. 10 is a graphical representation of hypothetical fragrance delivery data for an embodiment of a liquid atomization device incorporating three fragrances in accordance with the present invention.

### DETAILED DESCRIPTION OF THE INVENTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As used herein, the term “AC power supply” refers to an energy storage element that generates an electric current or voltage that reverses direction at regularly recurring intervals. The term “atomize” is used to refer to a process of converting a liquid to minute particles or a fine spray that may be entrained in a gas.

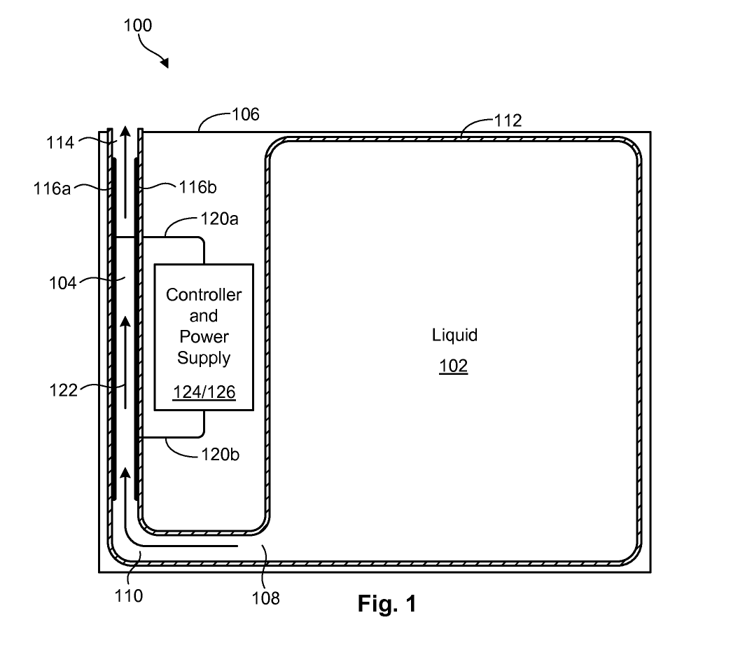

FIG. 1 illustrates one embodiment of a liquid atomization device 100 in accordance with the invention. The liquid atomization device 100 may include a liquid reservoir 102 to contain a liquid prior to atomization and dispersal, and a liquid pathway 104 to receive a beneficial liquid, atomize at least a portion of the liquid, and direct the atomized liquid to an external target zone. A beneficial liquid may include, for example, a fragrance, an insect repellant, an insecticide, or any other liquid imparting a beneficial effect known to those in the art. In some embodiments, the liquid reservoir 102 and/or liquid pathway 104 may be substantially encased within a housing 106.

The liquid reservoir 102 may include at least one opening 108 communicating with an end 110 of the liquid pathway 104. In certain embodiments, the liquid reservoir 102 may include substantially rigid walls 112, and may be vented to permit liquid contained therein to passively flow from the reservoir 102 to the liquid pathway 104 under the influence of gravity. Alternatively, the walls 112 of the liquid reservoir 102 may be substantially elastic, such that the reservoir 102 has a collapsible, variable volume. In this manner, embodiments of the invention may avoid a partial vacuum that may otherwise result in the reservoir 102 as liquid volume is drawn out of the liquid pathway 104 through the vaporizing and atomizing process.

Of course, one skilled in the art will recognize that a flow of liquid from the liquid reservoir 102 to the liquid pathway 104 may be accomplished by various means, including for example, a diaphragm pump, a centrifugal pump, a gas-generation pump, or by any other suitable means known to those in the art. In any case, as liquid mass is expelled from an open end 114 of the liquid pathway 104, additional liquid may enter the pathway 104 through the end 110, thus continuing the atomizing and dispersal process.

The liquid pathway 104 may be substantially elongate, and may be oriented such that the opening or end 114 communicating with the target zone may be hydraulically higher than the opening or end 110 communicating with the liquid reservoir 102. Further, in some embodiments, the surface area of the opening or end 114 communicating with the target zone may be small relative to the volume of liquid contained in the pathway 104, thereby limiting passive liquid evaporation resulting from exposure to the ambient environment.

In order to atomize the liquid passing therethrough, two or more electrodes 116a, 116b may be positioned within the liquid pathway 104. The electrodes 116a, 116b may be made of metals, carbides, conductive polymers, conductive ceramics, or other materials that are electrically conductive and stable in the presence of the beneficial liquid.

During operation, liquid may be received into the liquid pathway 104 from the opening 108 in the liquid reservoir 102. Power may be applied to the electrodes 116a, 116b by an AC power supply 126 and attached leads 120a, 120b to produce an alternating current through the liquid. Depending on the specific characteristics of the liquid and the voltage and frequency of the AC signal, a corona may form in the liquid resulting in resistive heating and vaporization. The rate of heat generation from resistive heating or corona may depend on the resistance of the liquid, the voltage and frequency of the AC signal, and geometric factors such as electrode spacing and electrode area. As the liquid temperature rises, a portion of the liquid may vaporize. Buoyancy or volume expansion may cause the vaporized liquid 122 to rise through the liquid pathway 104 to its open end 114. As the vapor 122 is expelled, a portion of the liquid may be carried with the vapor in the form of atomized droplets.

The liquid atomization device 100 may use AC power as opposed to DC power to atomize the liquid for several reasons. First, many liquids may not be electrically or ionically conductive and therefore may not readily conduct DC current. Second, in cases where the liquids do conduct DC current, the DC current can cause decomposition reactions at the electrodes, resulting in fouling of the electrodes 116a, 116b and reduced currents due to reduced conductivity through the decomposition products. As a result, the liquid atomization device 100 may utilize an AC power supply 126 to generate an alternating current through the liquid.

In certain embodiments, the AC power supply 126 may be configured to generate a high frequency alternating current (“HFAC”) through the liquid between electrodes 116a, 116b. In such embodiments, the electrodes 116a, 116b may be spaced relatively close together, creating a limited electrode zone or area between electrodes 116a, 116b. The use of HFAC may enable current to pass through non-conductive liquids that may otherwise act as insulators for DC current. For example, in an experiment performed by the instant inventors, it was discovered that a DC current was not able to pass through a citrus liquid fragrance manufactured by Fragrance Oil Ltd., but a high frequency current of 43.6 kHz was able to be successfully conducted through the same liquid.

In certain embodiments, a controller 124 may be provided to control one or more parameters of the AC power supply 126 responsible for generating a current between the electrodes 116a, 116b. Such parameters may affect, for example, the voltage or frequency of the AC signal, a duty cycle of the power supply 126, an on/off period of the power supply 126, or the like. For example, in one embodiment, the controller 124 may control the liquid dispensing rate by applying AC power to the electrodes 116a, 116b in periodic intervals (as with a duty cycle). In other embodiments, the controller 124 may control the liquid dispensing rate by adjusting the frequency and/or voltage of the AC signal.

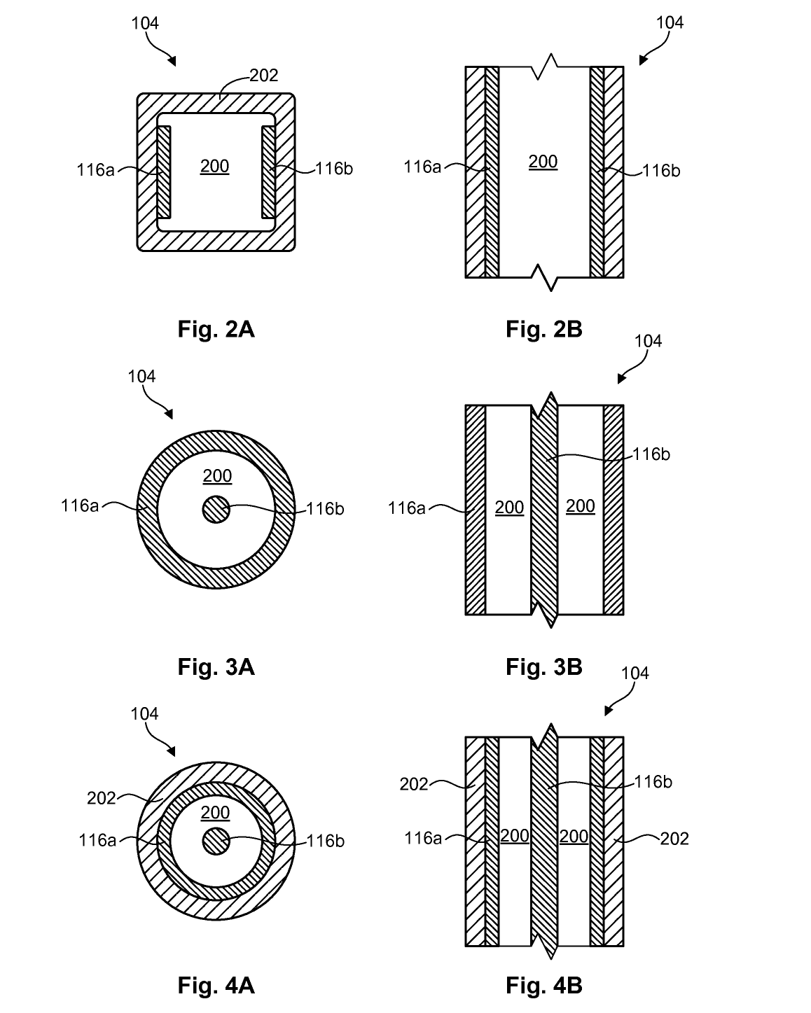

Referring now to FIGS. 2A and 2B, in certain embodiments, a liquid pathway 104 for use with the liquid atomization device 100 may include two independent and electrically isolated electrodes 116a, 116b positioned within an outer casing 202. As shown, the electrodes 116a, 116b may be positioned within the liquid pathway 104 and oriented substantially parallel relative to one another. One skilled in the art will recognize, however, that the electrodes 116a, 116b may be oriented in various ways and positioned in various locations within the liquid pathway 104, and that the present invention is not limited to the configuration shown. For example, in certain embodiments, one electrode 116a may be positioned at or near one end 114 of the liquid pathway 104 and the other electrode 116b may be positioned at or near the opposite end 110 of the liquid pathway 104, thereby increasing the length of the current path through the liquid.

During operation, liquid may be received into an annulus or channel 200 between the two electrodes 116a, 116b, thereby providing a conductive or semi-conductive medium through which a current may pass. In some embodiments, the liquid may act as a dielectric material directly exposed to the electrodes 116a, 116b within the liquid pathway 104. As sufficient voltage is applied to the liquid at an appropriate frequency and exceeding the breakdown voltage, a corona may form within the liquid. The current or corona may generate heat, which may vaporize a portion of the liquid. The vapor exiting the liquid pathway 104 may entrain atomized liquid.

FIGS. 3A and 3B illustrate an embodiment of the invention having one electrode 116a forming the outer wall or periphery of the liquid pathway 104. Specifically, in the illustrated embodiment, the electrodes 116a, 116b may be positioned substantially concentrically relative to one another, such that one electrode 116a forms the outer wall or periphery of the liquid pathway 104, while the other electrode 116b forms its core. An annulus 200 to accommodate a flow of liquid may be formed therebetween. In certain embodiments, insulating spacers (not shown) may be placed at the ends 110, 114 of the pathway 104 to center the core electrode 116b with respect to the outer electrode 116a.

Referring now to FIGS. 4A and 4B, another embodiment of a liquid pathway 104 may include a casing 202 surrounding an outer electrode 116a. As shown, the electrodes 116a, 116b are arranged substantially concentrically relative to one another. In certain embodiments, the casing 202 may be constructed from a thermally and/or electronically insulating material, such as polypropylene, polyethylene, polytetrafluoroethylene (“PTFE”), oxide ceramic, nitride ceramic, glass, or the like. In certain embodiments, the casing 202 may be substantially impermeable to liquid, thereby enabling utilization of one or more substantially porous electrodes 116a, 116b. Such a casing 202 may also prevent heat loss from the liquid and may demonstrate low thermal mass. As a result, the liquid may heat more quickly when power is applied to the electrodes 116a, 116b, thereby providing faster activation response. In addition, the reduced heat loss and thermal mass may reduce the amount of energy needed to vaporize the liquid. This may create a liquid atomization device 100 that is more energy efficient and, in some embodiments, may reduce the size and weight of a battery used to operate the liquid atomization device 100.

The following are two non-limiting examples of devices that were made and tested in accordance with embodiments of the invention.

### EXAMPLE 1

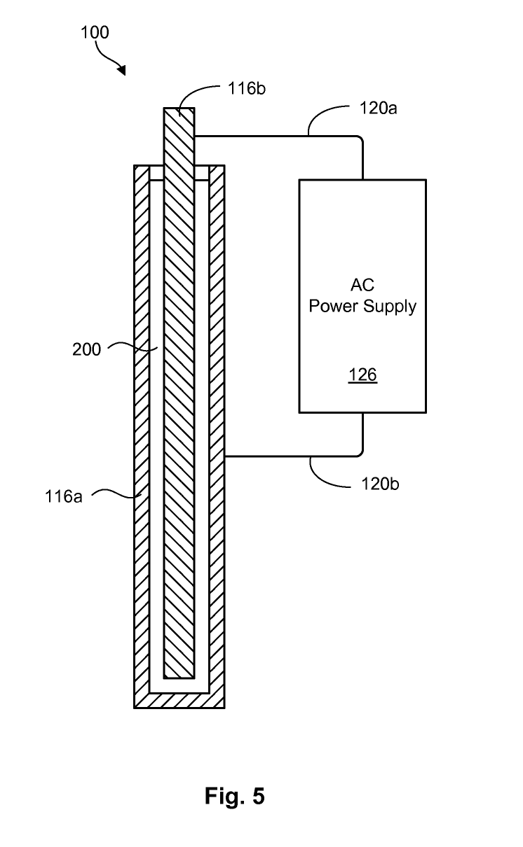

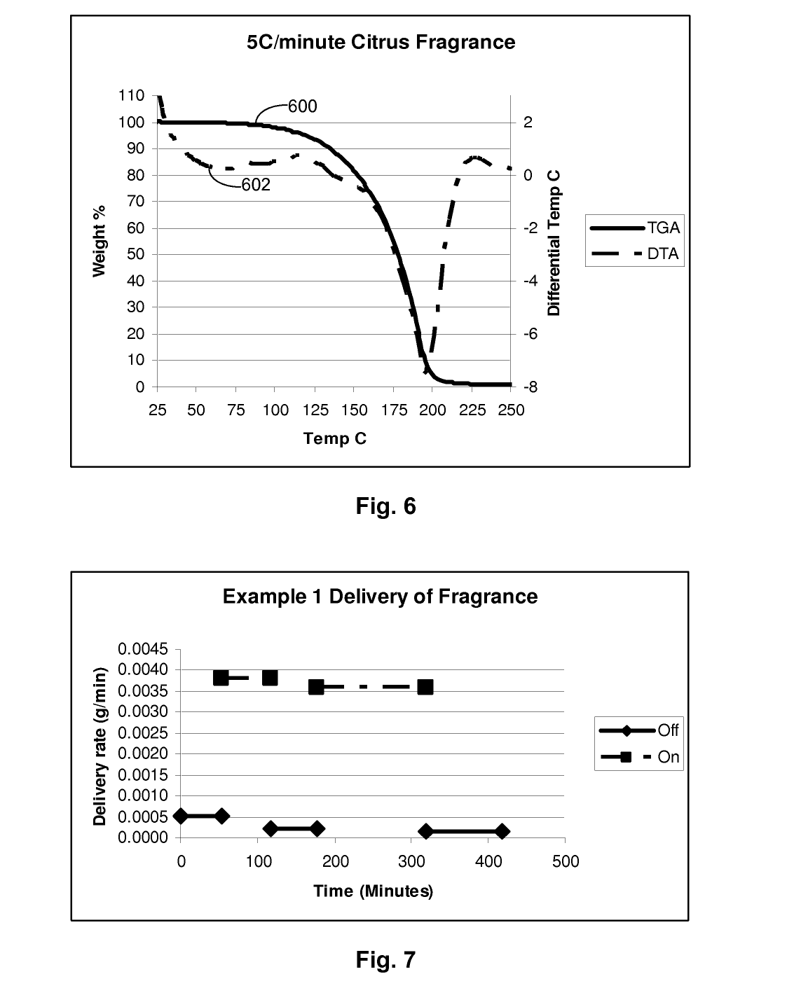

A liquid atomization device (similar to that shown in FIG. 5) was made by fabricating a device 100 with two concentric electrodes 116a, 116b, spaced apart from each other by an insulating nylon line. The outer electrode 116a area measured 3.534 square inches, while the inner electrode 116a area measured 2.356 square inches. The area of the outlet where liquid is exposed to the atmosphere was 0.06135 square inches. Fragrance was the liquid selected for delivery. The power supply 126 was a 15V DC power supply connected to a circuit that converted the signal to HFAC, and the frequency was set at 43.57 kHz. Standard thermogravimetric and differential thermo analysis tests were performed on a Simultaneous Thermal Analysis 409 (“STA 409”) manufactured by Netzsch. The results of these tests are shown in FIG. 6.

Particularly, FIG. 6 is a plot (shown by the solid line 600) of fragrance weight percent not vaporized versus temperature as the fragrance was heated at a rate of 5° C. per minute, and a plot (shown by the broken line 602) of temperature difference between the sample and a control pan with no sample with respect to temperature. The plots show that approximately ten percent (10%) of the fragrance vaporizes exothermically below 140° C. Above that temperature, heat must be applied for the remaining ninety percent (90%) of the fragrance to be delivered via vaporization and atomization.

When 15V DC power was applied to the electrodes 116a, 116b, there was no appreciable current through the liquid. As a result, there was a negligible difference between the fragrance delivery (determined by weight loss) with the 15V DC power applied, and a control when the power was off. On the other hand, when 15V DC power was applied through a set of circuits designed to convert DC power to HFAC, the fragrance delivery rate increased from a baseline to a level more than ten times above the baseline, as shown in FIG. 7.

### EXAMPLE 2

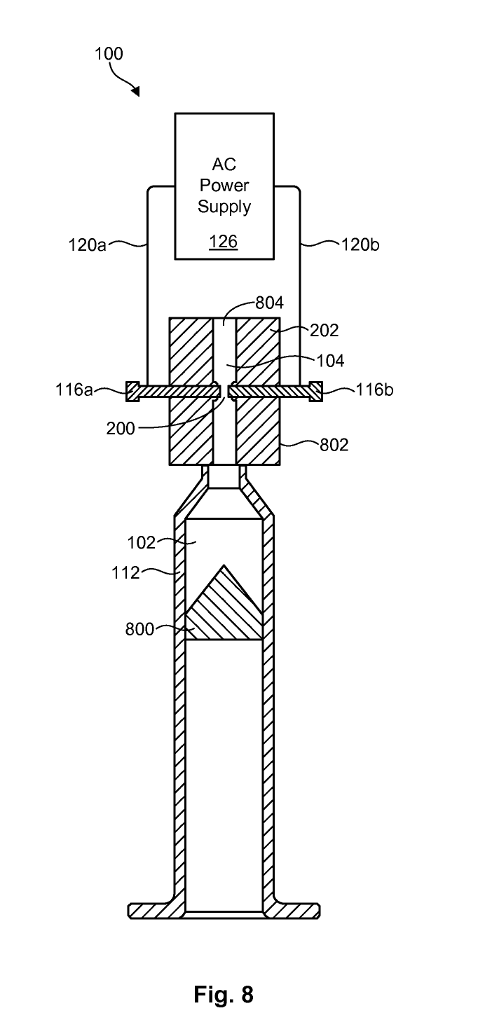

As shown in FIG. 8, a liquid atomization device 100 was made by fabricating a device 100 having a variable volume liquid reservoir 102, in this case a syringe with a moving piston 800. The device 100 included a liquid pathway 104 defined by a housing 802 constructed of a polymer. The liquid pathway 104 was in liquid communication with the liquid reservoir 102 and a vapor outlet 804. The open area of the vapor outlet 804 was 0.0475 square inches. Two electrodes 116a, 116b (having an electrode area of 0.345 square inches each) were exposed to liquid flow between the reservoir 102 and the outlet 804. Each electrode was connected to a 12V DC power supply 126 connected to a circuit that converts the signal to HFAC. Fragrance was the liquid selected for delivery, and was contained in a variable volume reservoir 102 in fluid communication with the electrodes 116a, 116b.

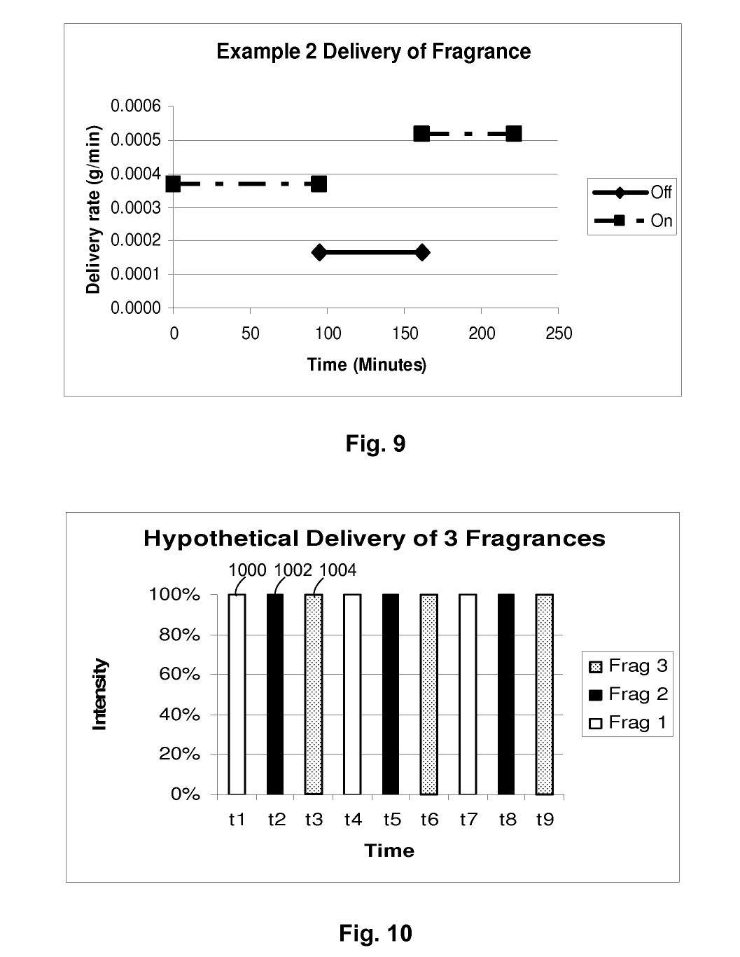

The experiment was conducted in the same manner as Example 1, with the frequency set at 43.57 kHz. The resulting delivery rates are shown in FIG. 9.

Referring now to FIG. 10, some embodiments of a liquid atomization device 100 in accordance with the invention may include more than one liquid reservoir 102, thereby enabling atomization of more than one liquid and/or providing an additional supply of a particular liquid for delivery.

In one embodiment, a liquid atomization device 100 in accordance with the invention may include multiple liquid reservoirs 102, each containing a different beneficial liquid. Each reservoir 102 may be connected to a unique liquid pathway 104 leading to a unique grouping of electrodes 116, or “electrode zone,” and outlet. A controller 124 may communicate with the power supply 126 to alternate power from one electrode zone to another. In this manner, one liquid may be delivered for one period of time, and other liquids may be delivered for subsequent periods of time. In certain embodiments, the duration of the on/off periods or duty cycle may be adjusted as desired. In cases where the beneficial liquids are fragrances, such an embodiment may prevent a user from developing a fragrance tolerance that may otherwise develop where a single fragrance is delivered substantially continuously.

This type of cyclical or periodic delivery of different fragrances or beneficial liquids may be facilitated by the heating efficiencies and quick response of liquid atomization devices 100 and methods in accordance with the present invention. Indeed, directly heating the liquid via an alternating current may avoid a lag time between the time that electrical power is applied and the time that atomizing delivery begins. Likewise, direct heating combined with limited exposure of the beneficial liquid to the external environment may facilitate quick shut-off and limit unintended liquid loss due to evaporation. These features may enable cyclical or periodic delivery of various fragrances with limited fragrance overlap and waste.

A hypothetical example of this type of liquid atomization device 100 is illustrated in FIG. 10. In this exemplary embodiment, the liquid atomization device 100 includes three liquid reservoirs 102 retaining three different liquid fragrances. Power may be cycled from one electrode zone to another, such that one fragrance 1000 may be delivered for one period of time, followed by delivery of a second fragrance 1002 for a second period of time, and delivery of a third fragrance 1004 for a third period of time.

The present invention may be embodied in other specific forms without departing from its basic principles or essential characteristics. The described embodiments are to be considered in all respects as illustrative and not restrictive. The scope of the invention is, therefore, indicated by the appended claims rather than by the foregoing description. All changes which come within the meaning and range of equivalency of the claims are to be embraced within their scope.

1. A device for atomizing a liquid for delivery to a target zone, the device comprising:
a liquid reservoir to contain a liquid;
a liquid pathway having a first end communicating with the liquid reservoir and a second end communicating with a target zone, wherein the liquid pathway receives at least a portion of the liquid from the liquid reservoir;
a first electrode and a second electrode positioned within the liquid pathway to accommodate the liquid therebetween; and
an AC power supply connected to each of the first and second electrodes to generate an alternating current through the liquid, thereby atomizing at a least a portion of the liquid for delivery to the target zone.

2. The device of claim 1, further comprising a controller to control at least one parameter of the AC power supply.

3. The device of claim 2, wherein the at least one parameter is selected from the group consisting of a voltage, a frequency, a duty cycle, and an on/off period associated with the AC power supply.

4. The device of claim 1, wherein the liquid reservoir comprises a substantially elastic housing to passively expand and collapse in accordance with a volume of liquid contained therein.

5. The device of claim 4, wherein the substantially elastic housing passively transports at least a portion of the liquid into the liquid pathway upon collapse.

6. The device of claim 1, wherein the first and the second electrodes are one of substantially concentric and substantially parallel relative to one another.

7. The device of claim 1, wherein one of the first and second electrodes is located near the first end of the liquid pathway and the other of the first and second electrodes is located near the second end of the liquid pathway to increase a length of the alternating current through the liquid.

8. The device of claim 1, wherein at least one of the first and the second electrodes is coupled to a dielectric material to insulate the at least one of the first and the second electrodes.

9. The device of claim 1, further comprising a mechanical pump to force at least a portion of the liquid from the liquid reservoir into the liquid pathway.

10. The device of claim 1, wherein the liquid comprises at least one of a fragrance, an insect repellant, and an insecticide.

11. A method for atomizing a liquid for delivery to a target zone, the method comprising:
containing a liquid within a liquid reservoir;
enabling at least a portion of the liquid to flow into a liquid pathway in communication with the liquid reservoir, the liquid pathway having an end communicating with a target zone;
positioning a first electrode and a second electrode within the liquid pathway to accommodate the liquid;
applying AC power to each of the first and second electrodes to generate an alternating current through the liquid, thereby atomizing at least a portion of the liquid; and
directing the atomized liquid through the end of the liquid pathway in communication with the target zone.

12. The method of claim 11, further comprising controlling at least one parameter of the AC power.

13. The method of claim 12, wherein the at least one parameter is selected from the group consisting of a voltage, a frequency, a duty cycle, and an on/off period associated with the AC power.

14. The method of claim 11, wherein the liquid reservoir comprises a substantially elastic housing to passively expand and collapse in accordance with a volume of liquid contained therein.

15. The method of claim 14, further comprising passively transporting at least a portion of the liquid to the liquid pathway upon the elastic housing collapsing in accordance with a volume of liquid contained therein.

16. The method of claim 11, wherein the first and the second electrodes are one of substantially concentric and substantially parallel relative to one another.

17. The method of claim 11, wherein positioning a first electrode and a second electrode within the liquid pathway to accommodate the liquid further comprises positioning each of the first and the second electrodes near opposite ends of the liquid pathway to increase a length of the alternating current through the liquid.

18. The method of claim 11, further comprising coupling at least one of the first and second electrodes to a dielectric material to insulate the at least one of the first and second electrodes.

19. The method of claim 11, wherein the liquid comprises at least one of a fragrance, an insect repellant, and an insecticide.

20. A method for delivering a liquid to a target zone, the method comprising:
providing a beneficial agent in the form of a liquid;
positioning at least two electrodes in communication with the liquid such that the at least two electrodes are spatially separated from one another;
applying AC power to the at least two electrodes;
generating an alternating current through the liquid to atomize at least a portion of the liquid; and
delivering the atomized liquid to a target zone.
